(19) United States
(12) Patent Application Publication
(10) Pub. No.: US 2024/0001283 A1
(43) Pub. Date: Jan. 4, 2024

(54) Carbon Dioxide Capture

(71) Applicant: Air Products and Chemicals, Inc., Allentown, PA (US)

(72) Inventors: Todd M. Moyle, Allentown, PA (US); Paul Higginbotham, Guildford (GB); Dingjun Wu, Macungie, PA (US); Gowri Krishnamurthy, Sellersville, PA (US); Michelle Roaf, Witley (GB); Christer Haugland, Kristiansand (GB)

(73) Assignee: Air Products and Chemicals, Inc., Allentown, PA (US)

(21) Appl. No.: 17/856,075

(22) Filed: Jul. 1, 2022

(51) Int. Cl. B01D 53/04; C04B 7/36; B01D 53/047; B01D 53/22; B01D 53/26; F25J 3/06

(52) U.S. Cl. CPC B01D 53/0438; C04B 7/367; B01D 53/047; B01D 53/229; B01D 53/261; B01D 53/226; F25J 3/067; B01D 2053/221; B01D 2256/12; B01D 2256/22; B01D 2257/302; B01D 2257/404

(57) ABSTRACT

A method for capturing carbon dioxide from a carbon dioxide feed stream in which the carbon dioxide feed stream is dehydrated, cooled, and partially condensed. The partially condensed carbon dioxide stream is separated to form the carbon dioxide product stream. The carbon dioxide feed stream is produced by combusting a fuel stream with an oxygen-enriched gas stream with less than 92% purity.

### BACKGROUND

The present disclosure relates generally to the capture of carbon dioxide produced by oxyfuel combustion and, more specifically, to systems and methods of integrating the oxygen production process with the carbon capture process.

Existing industrial processes such as power generation, lime production, or cement production will need to capture carbon dioxide (CO2) to mitigate the effects of climate change. Captured CO2 streams typically require removal of light components such as nitrogen before utilization or sequestration, so removal of nitrogen from air prior to combustion is preferred. This so-called oxyfuel combustion improves the efficiency of CO2 capture as well as increasing both the flame temperature (leading to higher rates of radiation heat transfer) and the rate of combustion kinetics (further leading to higher combustion efficiency).

Darde et al. (U.S. Pat. No. 9,109,831) teach a method of capturing CO2 from an oxyfuel process in which an air separation unit provides oxygen at 95-98% purity to the combustion process before purifying the resulting CO2 by distillation.

Leitgeb et al. (U.S. Pat. No. 8,808,427) teach a method of capturing CO2 from an oxyfuel process in which an air fractionation plant provides oxygen at 95-99.9% purity to the combustion process before purifying the resulting CO2 by adsorption.

Both the production of oxygen and capture of CO2 are energy intensive. There exists a need in the industry to improve the efficiency of the overall process by considering the oxygen production process and carbon capture process as an integrated whole.

### SUMMARY

This disclosure relates to a process to capture CO2 from a oxyfuel combustion process. An oxygen-enriched stream is produced by cryogenic distillation or vacuum swing adsorption and consumed by an oxyfuel combustor. CO2 from the resulting flue gas is separated and purified by a purification system comprising cooling and partial condensation steps. The purification system also produces a vent gas comprising unrecovered CO2 which may be separated by selective permeation to produce a CO2-enriched stream that may be recycled to the process upstream or downstream of the oxyfuel combustor.

Aspect 1: A method for capturing carbon dioxide from an carbon dioxide feed stream comprising combusting a fuel with an oxygen-enriched gas stream to produce the carbon dioxide feed stream; dehydrating the carbon dioxide feed stream to produce a dry carbon dioxide stream; cooling and partially condensing the dry carbon dioxide stream or a stream derived from the dry carbon dioxide stream to produce a cold carbon dioxide stream; and separating the cold carbon dioxide stream to produce a cold vent stream and a cold liquid carbon dioxide stream; wherein the oxygen-enriched gas stream has an oxygen purity of less than 92% by volume.

Aspect 2: A method according to Aspect 1, wherein the oxygen-enriched gas stream is produced by pressure swing adsorption.

Aspect 3: A method according to Aspect 1 or Aspect 2, further comprising expanding at least a portion of the cold liquid carbon dioxide stream to produce a low-pressure carbon dioxide stream; wherein the carbon dioxide feed stream is cooled by indirect heat exchange with one or more of the cold vent stream and the low-pressure carbon dioxide stream.

Aspect 4: A method according to any of Aspects 1 to 3, wherein the carbon dioxide feed stream comprises carbon dioxide formed by the reaction of a feedstock.

Aspect 5: A method according to any of Aspects 1 to 4, further comprising removing at least one of sulfur oxides and nitrogen oxides from the carbon dioxide feed stream.

Aspect 6: A method according to any of Aspects 1 to 5, further comprising heating the cold vent stream by indirect heat exchange to produce a vent stream; and separating the vent stream by selective permeation to produce a carbon dioxide-enriched permeate stream and a carbon dioxide-depleted retentate stream.

Aspect 7: A method according to Aspect 6, further comprising combining at least a portion of the carbon dioxide-enriched permeate stream with the oxygen-enriched gas stream.

Aspect 8: A method according to Aspect 6 or Aspect 7, further comprising compressing the carbon dioxide feed stream prior to dehydration; and combining at least a portion of the carbon dioxide-enriched permeate stream with the carbon dioxide feed stream prior to compression.

Aspect 9: A method according to any of Aspects 6 to 8, wherein the carbon dioxide feed stream is dehydrated by passing the carbon dioxide feed stream or a stream derived from the carbon dioxide feed stream through an online adsorber to produce a dry carbon dioxide stream and a loaded adsorber; and passing at least a portion of the carbon dioxide-depleted retentate stream through the loaded adsorber to regenerate the loaded adsorber and produce a spent regeneration gas stream.

Aspect 10: A method for capturing carbon dioxide from an carbon dioxide feed stream comprising combusting a fuel with an oxygen-enriched gas stream to produce the carbon dioxide feed stream and heat; compressing and cooling the carbon dioxide feed stream to produce a compressed carbon dioxide feed stream and a condensate stream; passing the compressed carbon dioxide feed stream through an online adsorber to produce a dry carbon dioxide stream and a loaded adsorber; cooling and partially condensing the dry carbon dioxide stream to produce a cold carbon dioxide stream; separating the cold carbon dioxide stream to produce a cold vent stream and a cold liquid carbon dioxide stream; expanding at least a portion of the cold liquid carbon dioxide stream to produce a low-pressure carbon dioxide stream; heating the cold vent stream and the low-pressure carbon dioxide stream by indirect heat exchange to produce a vent stream and a warm low-pressure carbon dioxide stream; separating the vent stream by selective permeation to produce a carbon dioxide-enriched permeate stream and a carbon dioxide-depleted retentate stream; and combining at least a portion of the the carbon dioxide-enriched permeate stream with one or more of the oxygen-enriched gas stream, the fuel, and the carbon dioxide feed stream; wherein the carbon dioxide feed is cooled by indirect heat exchange with one or more of the cold vent stream and the low-pressure carbon dioxide stream.

Aspect 11: A method according to Aspect 10, further comprising producing at least one of cement and/or lime.

Aspect 12: A method according to Aspect 10 or Aspect 11, further comprising removing mercury from the compressed carbon dioxide stream.

Aspect 13: A method according to any of Aspects 10 to 12, wherein the oxygen-enriched stream is produced by cryogenic distillation.

Aspect 14: A method according to any of Aspects 10 to 13, wherein the oxygen-enriched stream is produced by pressure swing adsorption.

Aspect 15: A method according to any of Aspects 10 to 14, further comprising removing at least one of sulfur oxides and/or nitrogen oxides from the compressed carbon dioxide stream.

Aspect 16: A system for capturing carbon dioxide from a carbon dioxide feed stream comprising an oxyfuel combustor configured to receive an oxygen-enriched stream and a fuel to produce the carbon dioxide feed stream and heat; a dehydrator configured to receive the carbon dioxide feed stream and produce a dry carbon dioxide stream; a carbon dioxide purification unit configured to receive the dry carbon dioxide stream and produce a vent stream and a cold liquid carbon dioxide stream; wherein the oxygen-enriched gas stream has an oxygen purity of less than 92% by volume.

Aspect 17: A system according to Aspect 16, further comprising an adsorption plant configured to produce the oxygen-enriched stream in fluid flow communication with the oxyfuel combustor.

Aspect 18: A system according to Aspect 16 or Aspect 17, wherein the carbon dioxide purification unit comprises a heat exchanger with a hot side inlet and a cold side inlet; a pressure reducer configured to expand the cold carbon dioxide liquid stream to produce a low-pressure carbon dioxide stream; wherein the hot side inlet is in fluid flow communication with the dry carbon dioxide stream and the cold side inlet is in fluid flow communication with the low-pressure carbon dioxide stream.

Aspect 19: A system according to any of Aspects 16 to 18, wherein the oxy-fuel combustor is configured to receive a feedstock; and wherein the reaction of the feedstock with heat generates carbon dioxide.

Aspect 20: A system according to any of Aspects 16 to 19, further comprising a single membrane stage, a plurality of membrane stages, or combinations thereof, configured to receive the vent stream to produce a carbon dioxide-enriched permeate stream and a carbon dioxide-lean retentate stream; and a feed compressor configured to receive the carbon dioxide feed stream upstream of the dehydrator, wherein the carbon dioxide-enriched permeate stream is in fluid flow communication with the carbon dioxide feed stream upstream of the feed compressor.

Aspect 21: A system according to Aspect 20, wherein the carbon dioxide-enriched permeate stream is in fluid flow communication with the oxygen-enriched gas stream.

Aspect 22: A system according to Aspect 20 or Aspect 21, wherein the dehydrator comprises an online adsorber in fluid flow communication with the carbon dioxide feed; and a loaded adsorber in fluid flow communication with the carbon dioxide-depleted retentate stream.

### BRIEF DESCRIPTION OF THE DRAWINGS

The present invention will hereinafter be described in conjunction with the appended figures wherein like numerals denote like elements:

FIG. 1 is a diagram depicting an embodiment of an oxyfuel combustion process with carbon capture.

FIG. 2 is a diagram depicting a detailed flow sheet of a CO2 purification system.

FIG. 3 is a plot of the total power required for a cyrogenic distillation cycle as a function of the oxygen purity feeding the oxyfuel combustor.

FIG. 4 is a plot of the total power required for a vacuum swing adsorption cycle as a function of the oxygen purity feeding the oxyfuel combustor.

### DETAILED DESCRIPTION

The ensuing detailed description provides preferred exemplary embodiments only, and is not intended to limit the scope, applicability, or configuration of the invention. Rather, the ensuing detailed description of the preferred exemplary embodiments will provide those skilled in the art with an enabling description for implementing the preferred exemplary embodiments of the invention. Various changes may be made in the function and arrangement of elements without departing from the spirit and scope of the invention, as set forth in the appended claims.

The articles “a” or “an” as used herein mean one or more when applied to any feature in embodiments of the present invention described in the specification and claims. The use of “a” and “an” does not limit the meaning to a single feature unless such a limit is specifically stated. The article “the” preceding singular or plural nouns or noun phrases denotes a particular specified feature or particular specified features and may have a singular or plural connotation depending upon the context in which it is used.

The phrase “at least a portion” means “a portion or all.” The “at least a portion of a stream” has the same composition, with the same concentration of each of the species, as the stream from which it is derived.

The term “and/or” placed between a first entity and a second entity includes any of the meanings of (1) only the first entity, (2) only the second entity, or (3) the first entity and the second entity. The term “and/or” placed between the last two entities of a list of 3 or more entities means at least one of the entities in the list including any specific combination of entities in this list. For example, “A, B and/or C” has the same meaning as “A and/or B and/or C” and comprises the following combinations of A, B and C: (1) only A, (2) only B, (3) only C, (4) A and B but not C, (5) A and C but not B, (6) B and C but not A, and (7) A and B and C.

The adjective “any” means one, some, or all, indiscriminately of quantity.

The terms “depleted” or “lean” mean having a lesser mole percent concentration of the indicated component than the original stream from which it was formed. “Depleted” and “lean” do not mean that the stream is completely lacking the indicated component.

The terms “rich” or “enriched” mean having a greater mole percent concentration of the indicated component than the original stream from which it was formed.

“Downstream” and “upstream” refer to the intended flow direction of the process fluid transferred. If the intended flow direction of the process fluid is from the first device to the second device, the second device is downstream of the first device. In case of a recycle stream, downstream and upstream refer to the first pass of the process fluid.

The term “indirect heat exchange” refers to the process of transferring sensible heat and/or latent heat between two or more fluids without the fluids in question coming into physical contact with one another. The heat may be transferred through the wall of a heat exchanger or with the use of an intermediate heat transfer fluid. The term “hot stream” refers to any stream that exits the heat exchanger at a lower temperature than it entered. Conversely, a “cold stream” is one that exits the heat exchanger at a higher temperature than it entered. A hot stream enters on a hot side inlet of the heat exchanger and a cold stream enters on a cold side inlet of the heat exchanger. A heat exchanger may have any number of hot side inlets and cold side inlets.

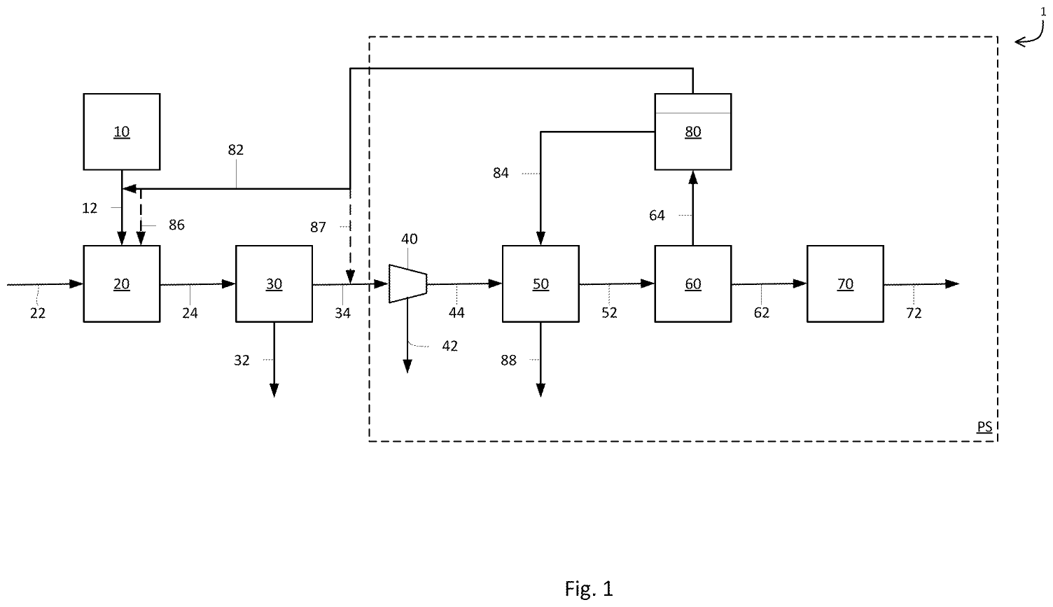

FIG. 1 shows an embodiment of a process 1 for oxyfuel combustion with carbon capture. An oxygen plant 10 produces an oxygen-enriched stream 12 which is combusted with fuel 22 in oxyfuel combustor 20 to produce heat and a flue gas 24. “Oxygen-enriched” is defined as any composition greater than the ambient concentration of 21% by volume. The oxyfuel combustor may be associated with any industrial process requiring heat such as power generation, lime production, and cement production. In at least some embodiments, the flue gas 24 comprises carbon dioxide generated by the reaction of a feedstock such as limestone due to the heat generated by the oxyfuel combustor. The oxygen plant 10 may be any industrial process such as cryogenic distillation or vacuum swing adsorption (VSA). If necessary, particulate matter 32 and impurities such as sulfur oxides and nitrogen oxides may be removed from the flue gas 24 in particulate removal system 30, leaving a carbon dioxide feed stream 34. A portion of the carbon dioxide feed stream may be recycled to the oxyfuel combustor 20 to control the temperature of the oxyfuel combustor 20. The carbon dioxide feed stream 34 then enters the purification section PS. If required, the carbon dioxide feed stream 34 may be compressed in compression system 40. The compression system 40 may comprise multiple stages of compression and may also comprise interstage coolers and/or aftercoolers. The compression and cooling may result in the formation of a condensate phase 42 which may comprise nitrogen and sulfur containing species such as nitrates, nitrites, sulfates, and/or sulfites due to dissolved NOx and SOx. If necessary, an additional processing step may be added to remove trace impurities such as mercury. The compressed carbon dioxide feed stream 44 enters a dehydration system 50 in which water is removed to form a dry carbon dioxide stream 52. The concentration of water in the dry carbon dioxide stream 52 may be below 5 ppm, below 3 ppm, or below 1 ppm, so that the dry carbon dioxide stream 52 may be cooled further without forming an ice and/or hydrate phase. The dehydration system 50 may comprise an absorption process such as triethylene glycol (TEG) and/or an adsorption process such as temperature swing adsorption (TSA) or pressure swing adsorption (PSA). The dry carbon dioxide stream 52 is then cooled and partially condensed in carbon dioxide purification unit 60. The carbon dioxide purification unit 60 separates the dry carbon dioxide stream 52 into a vent stream 64 and a purified carbon dioxide stream 62. In at least some embodiments, the purified carbon dioxide stream 62 may then enter final purification system 70 to produce a carbon dioxide product stream 72. Depending on the end use of sequestration or utilization, and/or on the transportation requirements, the final purification system 70 may comprise one or more of liquefaction, trace impurity removal such as oxygen and/or sulfur removal, dehydration, and compression.

In at least some embodiments, the vent stream 64 may be separated in a membrane separation system 80 which may comprise a single membrane stage or a plurality of membrane stages in series and/or parallel. The vent stream 64 is separated by selective permeation into a carbon dioxide-enriched permeate stream 82 and a carbon dioxide-lean retentate stream 84. Carbon dioxide selectively permeates the membrane over slower species such as nitrogen. In at least some example implementations, the higher solubility of carbon dioxide in the membrane material results in a faster permeation rate than similar-sized molecules with lower solubility such as nitrogen. At lower temperatures, the solubility of carbon dioxide increases which may increase the selectivity of carbon dioxide over nitrogen. In at least some example implementations, oxygen permeates at a rate between that of nitrogen and carbon dioxide.

Sanders et al (Polymer; vol 54; pp 4729-4761; 2013) provide a convenient summary of current membrane technology. They describe the physical parameters and performance characteristics of polymeric membranes including polystyrene, polysulfone, polyethersulfone, polyvinyl fluoride, polyvinylidene fluoride, polyether ether ketone, polycarbonate, polyphenylene oxide, polyethylene, polypropylene, cellulose acetate, polyimide (such as Matrimid 5218 or P-84), polyamide, polyvinyl alcohol, polyvinyl acetate, polyethylene oxide, polydimethylsiloxane, copolymers, block copolymers, or polymer blends. Existing industrially useful gas separations are performed primarily with polymers such as those listed above or rubbery materials such as silicone. Additional membrane materials may comprise mixed-matrix membranes, perfluoropolymers, thermally rearranged polymers, facilitated transport membranes, metal-organic frameworks, zeolitic-imidazolate frameworks, electrochemical membranes, metallic membranes, and carbon molecular sieves. The membrane material in the membrane separation system 80 can be any of those listed above, or any other material that has a faster permeation rate for some compounds such as carbon dioxide and a slower permeation rate for some compounds such as nitrogen.

Suitable membrane materials may be manufactured as hollow fibers and packaged as membrane bundles, or may be manufactured as flat sheets, packaged as spiral-wound or plate-and-frame units, in order to provide a larger surface area to volume ratio, and housed in a module. Gas entering the module contacts the membrane, and a fraction of the gas permeates through the membrane and leaves the module in the lower-pressure permeate stream. The faster permeating gases will be enriched in the permeate relative to the slower permeating gases. The fraction of the gas that does not permeate through the membrane leaves the module in the non-permeate, or retentate, stream which is enriched in the slower permeating gases relative to the faster permeating gases. A membrane stage is defined as one or more membrane modules arranged so that each feed inlet is in fluid flow communication with one another, each permeate outlet is in fluid flow communication with one another, and each retentate outlet is in fluid flow communication with one another.

The carbon dioxide-enriched permeate stream 82 may be recycled by combining with the oxygen-enriched stream 12, feeding the oxyfuel combustor 20 via line 86, and/or the carbon dioxide feed stream 34 via line 87. When the carbon dioxide-enriched permeate stream enters the oxyfuel combustor 20, any oxygen present will be consumed by the fuel. Conversely, when the carbon dioxide-enriched permeate stream is recycled to the carbon dioxide feed stream 34 via line 87, any oxygen present remains in the system. That oxygen may be removed by rejecting the oxygen to the carbon dioxide-depleted retentate stream 84, for example by reducing the surface area for permeation or by reducing the temperature of the membrane separation system and increasing the carbon dioxide selectivity over oxygen. In at least some embodiments, the dehydration system 50 comprises an adsorption system. The carbon dioxide-depleted retentate stream 84 may be used to regenerate the adsorption system, producing a spent regeneration stream 88 that may be recycled or vented. In at least some embodiments, the adsorption system may be regenerated with at least a portion of the vent stream 64.

A person of skill in the art will appreciate that other separation methods may be used to recover CO2 from the vent stream 64 and improve the overall CO2 recovery of the process. Preferably, the separation method will also recover oxygen from the vent stream which may be recycled to the oxyfuel combustor 20. One such alternative separation method is adsorption. In at least some embodiments, the membrane separation system may be replaced with a PSA process using an adsorbent that has a greater adsorption capacity for CO2 and O2 than N2, such as carbon molecular sieve. When the pressure of the adsorption bed is reduced, a stream enriched in CO2 and O2 relative to the vent stream 64 may be recycled to the oxyfuel comustor 20 or combined with the oxygen-enriched stream 12. Just as in the case of a membrane separation system, the PSA process improves overall CO2 recovery and reduces O2 demand.

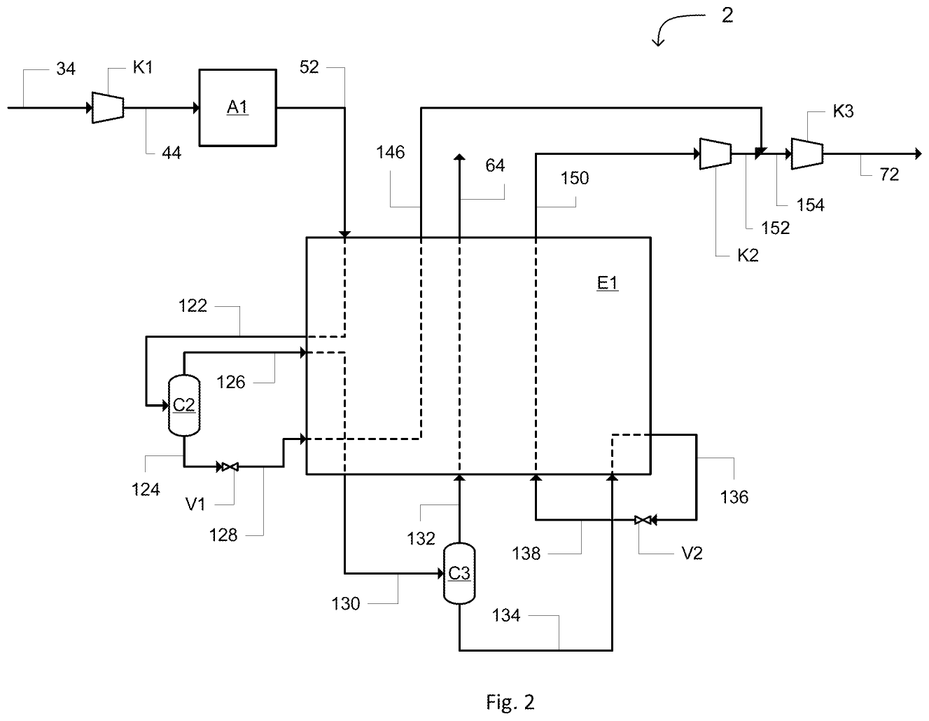

FIG. 2 shows an embodiment of a process 2 that shows the purification section PS in greater detail. In at least some embodiments, the carbon dioxide feed stream 34 is compressed in feed compressor K1. The compressed carbon dioxide feed stream 44 is passed through an online adsorber A1 that removes water and allows a dry carbon dioxide stream 52 to exit. The online adsorber A1 may utilize one or more high surface area adsorbents, including but not limited to zeolites, metal-organic frameworks (MOF), alumina, silica gel, silicalites, activated carbon, Engelhard titanosilicate (ETS), and metal oxides. Once the adsorbent is loaded with water, the loaded adsorber may be disconnected from the compressed carbon dioxide feed stream and regenerated with a gas stream such as at least a portion of the vent stream 64 and/or at least a portion of carbon dioxide-lean retentate stream 84.

The dry carbon dioxide stream 52 is cooled and partially condensed in a heat exchanger E1 to produce an intermediate carbon dioxide stream 122. The heat exchanger may comprise any type known in the art such as a plate and fin heat exchanger. The intermediate carbon dioxide stream 122 is separated in intermediate separator C2 to produce a first carbon dioxide liquid stream 124 and a first carbon dioxide vapor stream 126. The first carbon dioxide liquid stream 124 is then expanded across a pressure reducer such as valve V1 to produce a medium-pressure carbon dioxide stream 128 which provides refrigeration to the heat exchanger E1. In at least some embodiments, refrigeration may be provided by a closed loop external refrigerant such as ammonia, propane, carbon dioxide, or fluorocarbons.

The heat exchanger E1 represents a heat exchanger system that can be a single heat exchanger or be split into two or more heat exchangers in series or parallel. For example, the heat exchanger E1 may be divided into two separate heat exchangers between where intermediate carbon dioxide stream 122 exits and where first carbon dioxide vapor stream 126 enters.

The first carbon dioxide vapor stream 126 is further cooled and partially condensed in heat exchanger E1 to produce a cold carbon dioxide stream 130. The cold carbon dioxide stream 130 is then separated in cold separator C3, which may comprise a flash vessel and/or a column comprising trays and/or packing, to produce a cold vent stream 132 and a cold carbon dioxide liquid stream 134. The cold vent stream 132 provides refrigeration to the heat exchanger E1. The cold carbon dioxide liquid stream 134 may optionally be warmed in the heat exchanger E1 before being expanded across valve V2 to produce a low-pressure carbon dioxide stream 138 which provides refrigeration to the heat exchanger E1.

The medium-pressure carbon dioxide stream 128, the cold vent stream 132, and the low-pressure carbon dioxide stream 138 exit the heat exchanger E1 as warm medium-pressure carbon dioxide stream 146, vent stream 64, and warm low-pressure carbon dioxide stream 150, respectively. The warm low-pressure carbon dioxide stream 150 is compressed in first product compressor K2 and combined with warm medium-pressure carbon dioxide stream 146 to form a combined carbon dioxide product stream 154, which in turn is compressed in second product compressor K3 to form a carbon dioxide product stream 72. The carbon dioxide product stream 72 may also be formed by a single, multistage product compressor in which the warm low-pressure carbon dioxide stream 150 enters the feed stage and the warm medium-pressure carbon dioxide stream 146 enters an intermediate stage. The first product compressor K2 and the second product compressor K3 may comprise any compressor type including centrifugal, in-line, integral gear, axial, reciprocating, and diaphragm, in series and/or parallel.

Other possible arrangements for the purification system may be found in White et al. (U.S. Pat. No. 8,257,476). A person of ordinary skill in the art will appreciate that the carbon dioxide streams may be divided and let down to multiple pressures to improve the efficiency of the refrigeration provided in the heat exchanger E1.

### Example 1

A computer simulation of the process of FIG. 1 was carried out using Aspen Plus® process simulation software, available from Aspen Technology Inc, supplemented by proprietary oxygen plant data. The oxygen plant 10 produces an oxygen-enriched stream 12 comprising 50,000 Nm3/h of oxygen molecules at 25° C. to the oxyfuel combustor 20. Two types of oxygen plant were modeled: a cryogenic distillation plant with a purity of the oxygen-enriched stream 12 that was varied from 85% to 98%, and a vacuum swing adsorption (VSA) plant with a purity of the oxygen-enriched stream 12 that was varied from 85% to 94.5%. The pressure of the oxygen-enriched stream 12 was varied from 1.2 to 2.0 bara for both types. Unless stated otherwise all pressures are in absolute units. The oxyfuel combustor 20 is assumed to produce flue gas 24 at the conditions listed in Table 1.

TABLE 1

| | |
|---|---|
| Pressure (bara) | 1 |
| Temperature (deg C.) | 50 |
| SOx (mg/Nm\hat{ }3) | 50 |
| NOx (mg/Nm\hat{ }3) | 200 |
| HF (mg/Nm\hat{ }3) | 1 |
| HCl (mg/Nm\hat{ }3) | 10 |
| VOC (mg/Nm\hat{ }3) | 50 |
| NH3 (mg/Nm\hat{ }3) | 30 |
| Particulates (mg/Nm\hat{ }3) | 10 |
| Heavy Metals (mg/Nm\hat{ }3) | 0.5 |

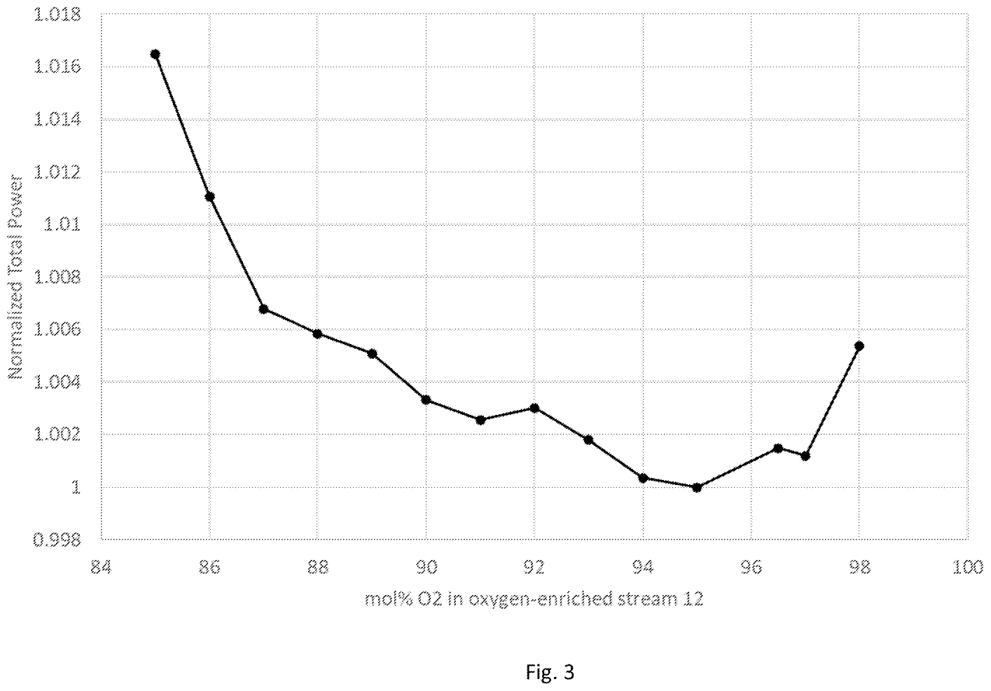

The power required for the purification section PS to produce a carbon dioxide product stream 72 at 97% purity (with a maximum O2 concentration of 0.7%) and 97% overall recovery is minimized and added to the power required for the oxygen plant 10. FIG. 3 shows a plot of total power required for the cryogenic distillation case, normalized to the minimum power at 95% O2 purity. The optimal oxygen purity is between 93% and 97%, or between 94% and 96%.

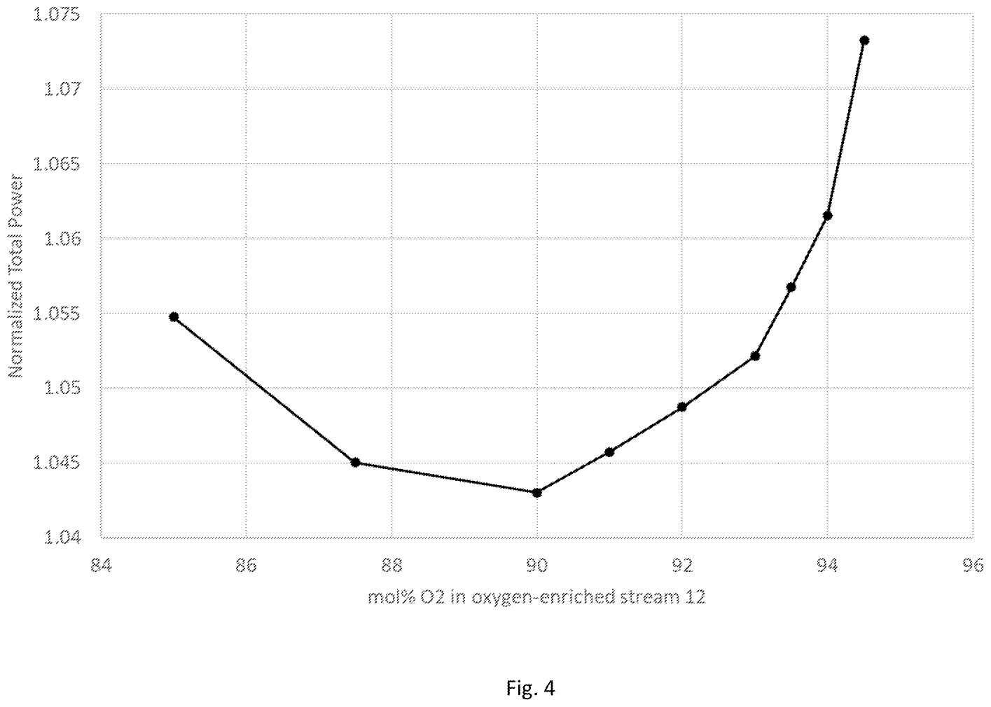

FIG. 4 shows a plot of total power required for the VSA case, again normalized to the minimum power at 95% O2 purity for the cryogenic distillation case. The optimal oxygen purity is less than 92%, or between 87% and 92%, or between 89% and 91%, much lower than the cryogenic distillation case. This is a counter-intuitive result because the higher concentration of impurities would be assumed to overload the purification section PS. In Allam et al. (Improved Oxygen Production Technologies, IEA GHG Report #2007/14, 2007), only oxygen purities above 95% are considered, and explicitly rule out VSA due to “only economic up to about 150 tonne/day capacity at purities of about 90% to 93%.” In fact, a comparison of FIGS. 3 and 4 will show that the overall optimum power of the VSA is greater than the overall optimum power of the cryogenic distillation process. However, the VSA gives benefits compared to cryogenic distillation including lower capital costs and faster construction times. Further benefits are provided by having multiple VSA units in parallel allowing faster startup times and a more reliable O2 supply.

### Example 2

A computer simulation of the process of FIG. 1 was carried out using Aspen Plus® process simulation software, available from Aspen Technology Inc. The oxygen plant 10 was modeled as a cryogenic distillation plant producing an oxygen-enriched stream 12 at a purity of 95%. The oxyfuel combustor 20 was modeled as a cement kiln in which CO2 is produced by combustion as well as decomposition of calcium carbonate. The vent stream 64 is separated in a single-stage polymeric membrane system 80, and the carbon dioxide-enriched permeate stream 82 is recycled. Two process options are compared in Table 2: case 1 in which the carbon dioxide-enriched permeate stream 82 is combined with the oxygen-enriched stream 12, and case 2 in which the carbon dioxide-enriched permeate stream is routed via line 87 to be combined with carbon dioxide feed stream 34. To maintain the same CO2 recovery of 97%, case 1 allows more O2 to slip through the membrane as it can be consumed in the oxyfuel combustor 20. In comparison, the membrane separation system 80 must be operated at −12° C. in case 2 to achieve a higher carbon dioxide selectivity, which requires a 50% increase in total membrane area.

TABLE 2

| | Case 1 | | | Case 2 | | |
|---|---|---|---|---|---|---|
| Stream | 64 | 82 | 84 | 64 | 87 | 84 |
| CO2 mol % | 25.8% | 64.2% | 17.6% | 25.7% | 78.4% | 11.6% |
| O2 mol % | 15.4% | 18.1% | 18.3% | 15.0% | 14.2% | 19.6% |
| N2 mol % | 51.9% | 14.0% | 57.1% | 49.5% | 5.3% | 61.3% |

### Example 3

A computer simulation of the process of FIG. 1 was carried out using Aspen Plus® process simulation software, available from Aspen Technology Inc. Two cases were modeled, Case 3 in which the oxygen-enriched stream 12 was produced by a cryogenic distillation plant at 95% purity, and Case 4 in which the oxygen-enriched stream 12 was produced by combining equal flow rates of a 95% O2 stream from a cryogenic distillation plant and an air stream with the ambient O2 purity of 21%. The resulting oxygen purity of the oxygen-enriched stream 12 in Case 4 is therefore 34.6%.

The total power requirement for Case 4 is 48% higher than Case 3, which is to be expected due to the larger amount of nitrogen the downstream process must separate. However, there would be situations where Case 4 is preferable. The advantages Case 4 has over Case 3 include a smaller cryogenic distillation plant and potentially lower temperatures in the oxyfuel combustor 20 due to the lower amount of oxygen enrichment. Case 4 may be preferred when the oxyfuel combustor 20 is producing cement or lime, as the carbon dioxide generated by the reaction of a feedstock such as limestone effectively dilutes the nitrogen in the flue gas 24 with additional CO2.

While the principles of the invention have been described above in connection with preferred embodiments, it is to be clearly understood that this description is made only by way of example and not as a limitation of the scope of the invention.

1. A method for capturing carbon dioxide from an carbon dioxide feed stream comprising:
combusting a fuel with an oxygen-enriched gas stream to produce the carbon dioxide feed stream;
dehydrating the carbon dioxide feed stream to produce a dry carbon dioxide stream;
cooling and partially condensing the dry carbon dioxide stream or a stream derived from the dry carbon dioxide stream to produce a cold carbon dioxide stream; and
separating the cold carbon dioxide stream to produce a cold vent stream and a cold liquid carbon dioxide stream;
wherein the oxygen-enriched gas stream has an oxygen purity of less than 92% by volume.

2. The method of claim 1, wherein the oxygen-enriched gas stream is produced by pressure swing adsorption.

3. The method of claim 1, further comprising expanding at least a portion of the cold liquid carbon dioxide stream to produce a low-pressure carbon dioxide stream;
wherein the carbon dioxide feed stream is cooled by indirect heat exchange with one or more of the cold vent stream and the low-pressure carbon dioxide stream.

4. The method of claim 1, wherein the carbon dioxide feed stream comprises carbon dioxide formed by the reaction of a feedstock.

5. The method of claim 1, further comprising removing at least one of sulfur oxides and nitrogen oxides from the carbon dioxide feed stream.

6. The method of claim 1, further comprising heating the cold vent stream by indirect heat exchange to produce a vent stream; and
separating the vent stream by selective permeation to produce a carbon dioxide-enriched permeate stream and a carbon dioxide-depleted retentate stream.

7. The method of claim 6, further comprising combining at least a portion of the carbon dioxide-enriched permeate stream with the oxygen-enriched gas stream.

8. The method of claim 6, further comprising compressing the carbon dioxide feed stream prior to dehydration; and
combining at least a portion of the carbon dioxide-enriched permeate stream with the carbon dioxide feed stream prior to compression.

9. The method of claim 6, wherein the carbon dioxide feed stream is dehydrated by passing the carbon dioxide feed stream or a stream derived from the carbon dioxide feed stream through an online adsorber to produce a dry carbon dioxide stream and a loaded adsorber; and passing at least a portion of the carbon dioxide-depleted retentate stream through the loaded adsorber to regenerate the loaded adsorber and produce a spent regeneration gas stream.

10. A method for capturing carbon dioxide from an carbon dioxide feed stream comprising:
combusting a fuel with an oxygen-enriched gas stream to produce the carbon dioxide feed stream and heat;
compressing and cooling the carbon dioxide feed stream to produce a compressed carbon dioxide feed stream and a condensate stream;
passing the compressed carbon dioxide feed stream through an online adsorber to produce a dry carbon dioxide stream and a loaded adsorber;
cooling and partially condensing the dry carbon dioxide stream to produce a cold carbon dioxide stream;
separating the cold carbon dioxide stream to produce a cold vent stream and a cold liquid carbon dioxide stream;
expanding at least a portion of the cold liquid carbon dioxide stream to produce a low-pressure carbon dioxide stream;
heating the cold vent stream and the low-pressure carbon dioxide stream by indirect heat exchange to produce a vent stream and a warm low-pressure carbon dioxide stream;
separating the vent stream by selective permeation to produce a carbon dioxide-enriched permeate stream and a carbon dioxide-depleted retentate stream; and
combining at least a portion of the the carbon dioxide-enriched permeate stream with one or more of the oxygen-enriched gas stream, the fuel, and the carbon dioxide feed stream;
wherein the carbon dioxide feed is cooled by indirect heat exchange with one or more of the cold vent stream and the low-pressure carbon dioxide stream.

11. The method of claim 10, further comprising producing at least one of cement and/or lime; and removing mercury from the compressed carbon dioxide stream.

12. The method of claim 10, wherein the oxygen-enriched stream is produced by cryogenic distillation.

13. The method of claim 10, wherein the oxygen-enriched stream is produced by pressure swing adsorption.

14. The method of claim 10, further comprising removing at least one of sulfur oxides and/or nitrogen oxides from the compressed carbon dioxide stream.

15. A system for capturing carbon dioxide from a carbon dioxide feed stream comprising:
an oxyfuel combustor configured to receive an oxygen-enriched stream and a fuel to produce the carbon dioxide feed stream and heat;
a dehydrator configured to receive the carbon dioxide feed stream and produce a dry carbon dioxide stream;
a carbon dioxide purification unit configured to receive the dry carbon dioxide stream and produce a vent stream and a cold liquid carbon dioxide stream;
wherein the oxygen-enriched gas stream has an oxygen purity of less than 92% by volume.

16. The system of claim 15, further comprising an adsorption plant configured to produce the oxygen-enriched stream in fluid flow communication with the oxyfuel combustor.

17. The system of claim 15, wherein the carbon dioxide purification unit comprises a heat exchanger with a hot side inlet and a cold side inlet; a pressure reducer configured to expand the cold carbon dioxide liquid stream to produce a low-pressure carbon dioxide stream;
wherein the hot side inlet is in fluid flow communication with the dry carbon dioxide stream and the cold side inlet is in fluid flow communication with the low-pressure carbon dioxide stream;
wherein the oxy-fuel combustor is configured to receive a feedstock; and wherein the reaction of the feedstock with heat generates carbon dioxide.

18. The system of claim 15, further comprising:
a single membrane stage, a plurality of membrane stages, or combinations thereof, configured to receive the vent stream to produce a carbon dioxide-enriched permeate stream and a carbon dioxide-lean retentate stream; and
a feed compressor configured to receive the carbon dioxide feed stream upstream of the dehydrator, wherein the carbon dioxide-enriched permeate stream is in fluid flow communication with the carbon dioxide feed stream upstream of the feed compressor.

19. The system of claim 18, wherein the carbon dioxide-enriched permeate stream is in fluid flow communication with the oxygen-enriched gas stream.

20. The system of claim 18, wherein the dehydrator comprises an online adsorber in fluid flow communication with the carbon dioxide feed; and a loaded adsorber in fluid flow communication with the carbon dioxide-depleted retentate stream.
